(19) United States
(12) Patent Application Publication
(10) Pub. No.: US 2025/0240615 A1
(43) Pub. Date: Jul. 24, 2025

(54) PUSH NOTIFICATION MANAGEMENT FOR A RESERVE eSIM CONNECTION

(71) Applicant: Apple Inc., Cupertino, CA (US)

(72) Inventors: Abishek Kumar VAIDYANATHAN, Union City, CA (US); Aniket A. ZAMWAR, Milpitas, CA (US); Li LI, Los Altos, CA (US); Mohanasundaram KATTAVOOR SIVAKUMAR, Mountain View, CA (US); Nelson M. LeDUC, San Jose, CA (US); Nithish Kulur PRABHAKARA, Sunnyvale, CA (US); Siddharth VERMA, Santa Clara, CA (US)

(21) Appl. No.: 18/915,667

(22) Filed: Oct. 15, 2024

Related U.S. Application Data
(60) Provisional application No. 63/624,707, filed on Jan. 24, 2024.

(51) Int. Cl. H04W 8/18; H04W 4/12; H04W 60/00; H04W 76/38

(52) U.S. Cl. CPC H04W 8/18; H04W 4/12; H04W 60/00; H04W 76/38

(57) ABSTRACT

This application sets forth techniques for managing push notifications for a reserve electronic subscriber identity module (eSIM) connection for a wireless device. A reserve eSIM is installed in the wireless device to provide a limited functionality connectivity option for essential services, such as device activation, user eSIM provisioning, user eSIM transfer, and user subscription account management. When a reserve eSIM is active, push notifications for a limited set of push notification topics are allowed to be communicated to the wireless device via the reserve eSIM connection.

### CROSS-REFERENCE TO RELATED APPLICATIONS

The present application claims the benefit of U.S. Provisional Application No. 63/624,707, entitled “PUSH NOTIFICATION MANAGEMENT FOR A RESERVE eSIM CONNECTION,” filed Jan. 24, 2024, the content of which is incorporated by reference herein in its entirety for all purposes.

### FIELD

The described embodiments set forth techniques for managing push notifications for a reserve electronic subscriber identity module (eSIM) connection for a wireless device. A reserve eSIM is installed in the wireless device to provide a limited functionality connectivity option for essential services, such as device activation, user eSIM provisioning, user eSIM transfer, and user subscription account management. When a reserve eSIM is active, push notifications for a limited set of push notification topics are allowed to be communicated to the wireless device via the reserve eSIM connection.

### BACKGROUND

Newer generation, fifth generation (5G), cellular wireless networks that implement one or more 3^{rd} Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Typically, wireless devices have been configured to use removable UICCs, that include at least a microprocessor and a read-only memory (ROM), where the ROM is configured to store an MNO profile, also referred to as subscriber identity module (SIM) or SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs or integrated with other system components as iUICCs, which can provide advantages over traditional, removable UICCs. The eUICCs and/or iUICCs can include a rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. An eUICC/iUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

A wireless device can include a reserve eSIM, also referred to as a bootstrap eSIM, a backup eSIM, or a provisioning eSIM, installed at a time of manufacture or provided dynamically to the wireless device thereafter. The reserve eSIM provides a limited functionality connectivity option to allow the wireless device to connect to a cellular wireless network for essential services, such as upon initial device activation or for device configuration following a factory reset procedure. Additional conditions such as eSIM provisioning, eSIM transfer, and subscriber cellular service account management can benefit from the availability of a reserve eSIM. Currently push notifications are disallowed over a reserve eSIM connection to prevent applications from using the reserve eSIM connection for data transfer. Limiting the use of push notifications via the reserve eSIM connection can interfere or complicate procedures intended for reserve eSIM use. There exists a need for mechanisms to manage availability of select push notification messages via a reserve eSIM connection.

### SUMMARY

This Application sets forth techniques for managing push notifications for a reserve electronic subscriber identity module (eSIM) connection for a wireless device. A reserve eSIM is installed in the wireless device to provide a limited functionality connectivity option for essential services, such as device activation, user eSIM provisioning, user eSIM transfer, and user subscription account management. When a reserve eSIM is active, push notifications for a limited set of push notification topics are allowed to be communicated to the wireless device via the reserve eSIM connection.

A wireless device includes a reserve eSIM, also referred to as a bootstrap eSIM, a backup eSIM, or a provisioning eSIM, installed at a time of manufacture or provided dynamically to the wireless device thereafter. The reserve eSIM provides a limited functionality connectivity option to allow the wireless device to connect to a cellular wireless network for a limited set of services, such as to connect to original equipment manufacturer (OEM), e.g., device manufacturer, servers for device activation, to connect to mobile network operator (MNO) servers to provision, download and install a full functionality user eSIM or to assist with transfer of cellular wireless service for a user eSIM, to connect to MNO servers to manage a cellular wireless subscription account, or the like. The reserve eSIM can be in an inactive state, where the inactive state restricts the wireless device from establishing a connection with the cellular wireless network via the reserve eSIM until activated. The wireless device monitors one or more conditions that indicate use of the reserve eSIM may be warranted. Exemplary conditions can include when a user eSIM is installed but not yet activated, when cellular connectivity via an installed user eSIM is unavailable, when cellular connectivity via a user eSIM is only available via a roaming network, when Internet connectivity is unavailable via a non-cellular wireless connection, or the like. The wireless device reconfigures the reserve eSIM from the inactive state to an active state when required for wireless connectivity and wireless or wired connectivity is otherwise unavailable to the wireless device. The wireless device establishes a connection to a cellular wireless network via the reserve eSIM and initiates a new or resumes use of a previous cellular wireless network session with a device manufacturer push notification server via the reserve eSIM connection. The wireless device registers with the push notification server to receive push notifications for one or more push notification topics via the reserve eSIM connection. The push notification server registers with application servers corresponding to the push notification topics for the wireless device to receive applicable push notification messages via the reserve eSIM connection. The push notification server can filter push notifications to ensure only those push notification messages allowed for use via a reserve eSIM connection are sent to the wireless device via the reserve eSIM connection. The wireless device can implement a time limit procedure to manage time periods when the reserve eSIM connection is active, where the reserve eSIM can be inactive outside the time periods.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3 illustrates an exemplary device activation and provisioning network for a wireless device, according to some embodiments.

FIG. 4A illustrates an exemplary state diagram for a reserve eSIM, according to some embodiments.

FIG. 4B illustrates an exemplary activation flow for use of a reserve eSIM, according to some embodiments.

FIGS. 5A and 5B illustrate an example of push notification management via a reserve eSIM connection for a wireless device, according to some embodiments.

FIG. 6 illustrates an exemplary method for management of push notifications via a reserve eSIM connection by a wireless device, according to some embodiments.

FIG. 7 illustrates an exemplary method for management of push notifications via a reserve eSIM connection by a push notification server, according to some embodiments.

FIG. 8 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This Application sets forth techniques for managing push notifications for a reserve electronic subscriber identity module (eSIM) connection for a wireless device. A reserve eSIM is installed in the wireless device to provide a limited functionality connectivity option for essential services, such as device activation, user eSIM provisioning, user eSIM transfer, and user subscription account management. When a reserve eSIM is active, push notifications for a limited set of push notification topics are allowed to be communicated to the wireless device via the reserve eSIM connection.

A wireless device includes a reserve eSIM, also referred to as a bootstrap eSIM, a backup eSIM, or a provisioning eSIM, installed at a time of manufacture or provided dynamically to the wireless device thereafter. The reserve eSIM provides a limited functionality connectivity option to allow the wireless device to connect to a cellular wireless network for a limited set of services, such as i) to connect to original equipment manufacturer (OEM), e.g., device manufacturer, servers for device activation, ii) to connect to mobile network operator (MNO) servers to provision, download and install a full functionality user eSIM or to assist with transfer of cellular wireless service for a user eSIM, iii) to connect to MNO servers to manage a cellular wireless subscription account, or the like. The reserve eSIM can be in an inactive state, where the inactive state allows the wireless device to camp on a cellular wireless network with limited signaling but restricts the wireless device from establishing a connection with the cellular wireless network via the reserve eSIM until activated. The wireless device monitors one or more conditions that indicate use of the reserve eSIM may be warranted. Exemplary conditions can include when a user eSIM is installed but not yet activated, when cellular connectivity via an installed user eSIM is unavailable, when cellular connectivity via a user eSIM is only available via a roaming network, when Internet connectivity is unavailable via a non-cellular wireless connection, or the like. The wireless device reconfigures the reserve eSIM from the inactive state to an active state when required for wireless connectivity and wireless or wired connectivity is otherwise unavailable to the wireless device. In some cases, the wireless device indicates to one or more authorized applications or system resources that a reserve eSIM connection is available (or can be made available). Activation and use of the reserve eSIM connection can occur in the background and may be not directly visible to a user of the wireless device.

As there can be a cost associated with use of the reserve eSIM connection, e.g., cellular wireless service fees accrued to a device manufacturer that provides the reserve eSIM on the wireless device, use of the reserve eSIM connection is restricted. Present practice disallows push notifications via a reserve eSIM connection entirely; however, a blanket restriction can hinder user experience for certain essential services. As discussed herein, the reserve eSIM connection can be opened up for use by a limited set of applications or system resources that use push notification messages sent to the wireless device. Use of push notifications via the reserve eSIM connection can provide for improved or simplified procedures, such as during device activation or eSIM provisioning.

After the wireless device establishes a connection to a cellular wireless network via the reserve eSIM, the wireless device establishes a new (or resumes use of a previous) cellular wireless network session with a device manufacturer push notification server via the reserve eSIM connection. In some cases, when establishing or resuming the session with the device manufacturer push notification server, the wireless device can indicate that a reserve eSIM connection is being used. For example a header of a device capability (or other applicable) message can indicate use of the reserve eSIM connection to the device manufacturer push notification server. In some cases, the wireless device connects to the device manufacturer push notification server via a proxy server. In some cases, the device manufacturer push notification server identifies that the connection to the wireless device is via the reserve eSIM connection based on the connection being via a particular proxy server, e.g., a proxy server designated for reserve eSIM use. The device manufacturer push notification server can provide push notifications to the wireless device for various applications or system services. The reserve eSIM connection will be restricted for use by the wireless device to a limited set of push notification topics, i.e., only some push notification messages that can be communicated to the wireless device via a user eSIM cellular wireless connection (or via a non-cellular wireless connection) will be allowed to be communicated via the reserve eSIM connection. The wireless device registers with the push notification server to receive push notifications for one or more push notification topics permitted for use via the reserve eSIM connection. Only push notifications associated with allowed and registered push notification topics will be sent to the wireless device via the reserve eSIM connection. Exemplary push notification topics that can be allowed via the reserve eSIM connection can include: i) acquisition of a user eSIM by the wireless device when alternative connections are not available, ii) transfer of a user eSIM (or cellular service associated with a user eSIMO to the wireless device, and iii) device activation upon initial unboxing or after a factor reset. Current procedures use polling by the wireless device of application servers responsive to user actions, which can impede certain procedures, such as when the user does not perform a particular action that would poll the application server. In some cases, without push notifications via the reserve eSIM connection and without polling based on user actions, the wireless device can be unable to receive information regarding new cellular plans available for the wireless device or obtain new or updated activation policies for the wireless device. To overcome these limitations, the wireless device will be allowed to register for push notifications from a select set of push notification topics. The set of allowed notification topics can be adjusted dynamically in some cases, e.g., by a policy included in a device manufacturer software or firmware provided to the wireless device. The push notification server registers with application servers corresponding to the push notification topics for the wireless device to receive applicable push notification messages via the reserve eSIM connection. The device manufacturer push notification server restricts the push notifications sent to the wireless device via the reserve eSIM connection and can disallow sending or forwarding push notification messages that do not belong to the allowed set of push notification topics to the wireless device via the reserve eSIM connection. The device manufacturer push notification server can filter push notifications appropriately, and policies regarding push notification filtering can be updated at the device manufacturing push notification server without requiring changes to the wireless device. Use of the reserve eSIM connection can be limited by the wireless device, e.g., to be available for a number of minutes per hour per day. The wireless device can implement a time limit procedure to manage the time periods when the reserve eSIM connection is active, can the reserve eSIM can be inactive outside the time periods.

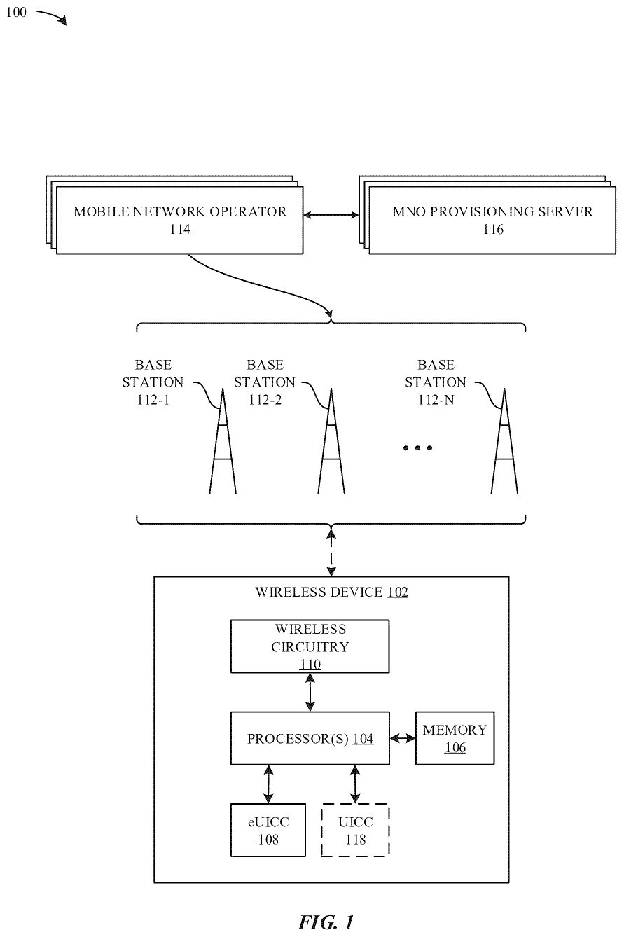

These and other embodiments are discussed below with reference to FIGS. 1-8; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUS)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and wireless circuitry 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, wireless circuitry 110, and UICC 118) can be arranged and combined in any number of configurations.

To be able to access services provided by an MNO, an eSIM can be reserved for subsequent download and installation to the eUICC 108. In some embodiments, the eUICC 108 obtains one or more eSIMs from one or more associated provisioning servers 116 as part of a device initialization of the wireless device 102, such as when purchasing a new wireless device 102. The provisioning servers 116 can be maintained by a manufacturer of the wireless device 102, the MNOs 114, third party entities, and the like. Communication of eSIM data between an MNO provisioning server 116 and the eUICC 108 (or between the MNO provisioning server 116 and processing circuitry of the wireless device 102 external to the eUICC 108, e.g., the processor 104) can use a secure communication channel.

In some cases, the wireless device 102 can lack an activated, fully functional cellular wireless eSIM on the eUICC 108 and can also not include a UICC 118 with an activated physical SIM (pSIM) installed in the wireless device 102. The user of the wireless device 102 can be required to activate, download, and/or configure a fully functional eSIM from an MNO provisioning server 116 to access cellular wireless services of a particular MNO with which the user establishes a cellular wireless subscription. The wireless device 102 can include a limited functionality reserve eSIM that can be initially configured in an inactive state. When an application authorized to use the reserve eSIM requires a wireless network connection, and no cellular wireless network connection or non-cellular wireless network connection is available or able to be established, the wireless device 102 can reconfigure the reserve eSIM from the inactive state to an active state to allow for establishing connections to a cellular wireless network via the reserve eSIM. In some cases, the reserve eSIM can be activated and a reserve eSIM connection established in the background for a system resource process, such as for receiving a limited set of push notification messages that can assist with various wireless device procedures. In some embodiments, a reserve eSIM connection to a device manufacturer push notification server can be established when conditions for receiving push notification messages for essential services are otherwise unavailable via alternative wireless or wired connections.

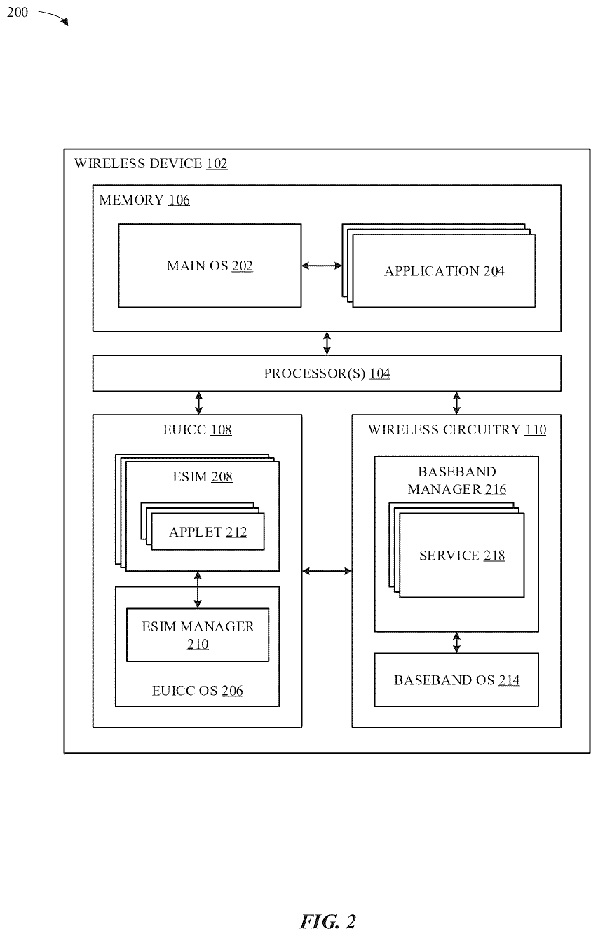

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and providing baseband wireless circuitry 110 with access to the eSIMs 208 to provide access to wireless services for the wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with baseband wireless circuitry 110 and the eUICC 108, can be configured to enable the wireless device 102 to communicate with an MNO 114 and provide useful features (e.g., phone calls and internet access) to a user of the wireless device 102.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server 116 and obtaining information (such as eSIM data) from the MNO provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108. For a reserve eSIM 208 that provides limited functionality restricted to certain data connections when certain conditions are satisfied, e.g., when a cellular wireless connection via a user eSIM 208 or a non-cellular wireless connection with Internet connectivity is unavailable, the wireless device 102 can recommend to one or more authorized applications and/or to system resources availability of the reserve eSIM. The wireless device 102 can reconfigure the reserve eSIM 208 from an inactive state to an active state, e.g., in response to an authorized application or system resource request for a network connection via the reserve eSIM. An applications processor, e.g., one of the processors 104, of the wireless device 102 can include modules to monitor for network conditions that warrant use of the reserve eSIM 208 and dynamically manage availability of the reserve eSIM for one or more applications. When conditions are satisfied to use the reserve eSIM 208, the reserve eSIM 208 can be recommended to one or more authorized applications and/or system resources. When conditions are not satisfied to use the reserve eSIM 208, the reserve eSIM 208 can be reconfigured to an inactive state from the active state. In some embodiments, a core telephony module resident on a processor 104 of the wireless device, e.g., an applications processor, can request a connection to a device manufacturer push notification server, and one or more device services daemons on the applications processor can determine whether a fully functional cellular eSIM connection or a non-cellular wireless connection is available for connecting to the device manufacturer push notification server. When no alternative (cellular wireless, non-cellular wireless, or wired) connection is available, the device services daemons can perform a procedure to request a reserve eSIM connection by which to communicate with the device manufacturer push notification server. Activating the reserve eSIM and connecting with the push notification server via the reserve eSIM connection can occur in the background to support various system processes, such as for device activation, user eSIM provisioning, user eSIM transfer, or the like.

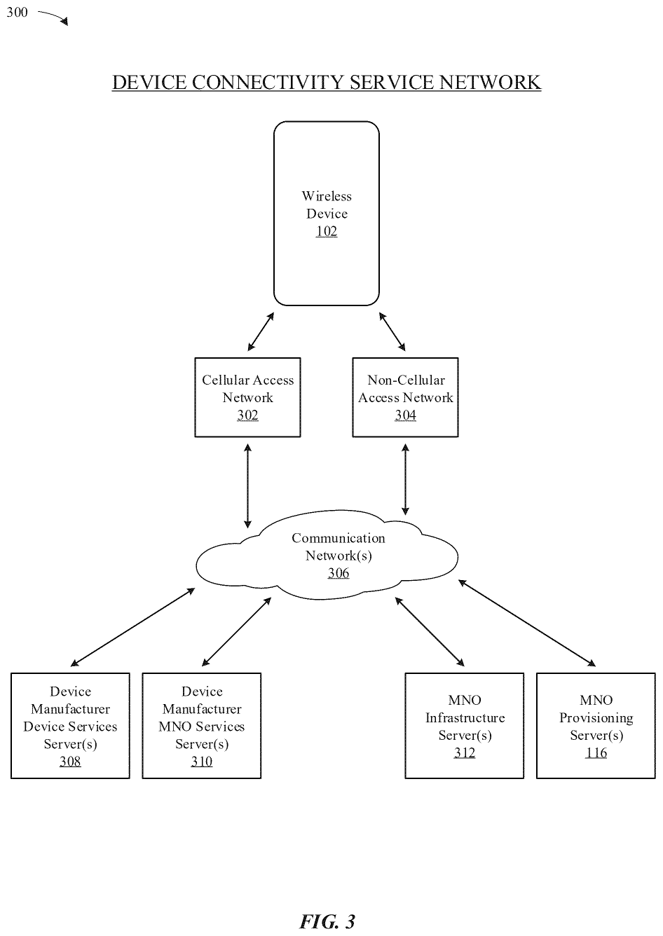

FIG. 3 illustrates a diagram 300 of elements of communication network involved in device activation and SIM provisioning, installation, and activation for a wireless device 102. Data connectivity for the wireless device 102 can be required for device activation and SIM provisioning (including in some cases an eSIM transfer). In some scenarios, a non-cellular access network 304 can be available for the wireless device 102 to connect to various device manufacturer managed and/or MNO 114 managed servers via intervening communication networks 306. In some scenarios, a non-cellular access network 304 may be not available, and the wireless device 102 may rely on access to a cellular access network 302 for activation of the wireless device 102 and/or for SIM provisioning, e.g., communicating with one or more MNO infrastructure servers 312 and/or one or more MNO provisioning servers 116, including downloading and installation of a user eSIM 208, to the wireless device 102. In some embodiments, the wireless device 102 includes a limited functionality SIM profile, e.g., a pre-installed limited functionality reserve eSIM 208, which can provide limited access to the cellular access network 302, such as for provisioning or transferring a user eSIM 208 to the wireless device 102 or to interact with MNO infrastructure servers 312 for managing a cellular wireless service subscription account. In some cases, the wireless device can also communicate with one or more device manufacturer servers 308, 310. Use of the reserve eSIM 208 can be based on monitored network conditions and recommended for use to particular applications authorized to use the reserve eSIM 208. An OEM manufacturer of the wireless device 102 can maintain multiple network-based servers to assist with management of the wireless device 102, e.g., one or more device manufacturer device services servers 308, which can provide management for device manufacturer supplied services to the wireless device 102, and one or more device manufacturer MNO services servers 310, which can provide a device manufacturer anchor for management of MNO supplied services to the wireless device 102. An exemplary device manufacturer devices services server 308 can be a device manufacturer push notification server that provides push notification messages to the wireless device 102. An exemplary device manufacturer MNO services server 310 can be a lookup server that provides information regarding eSIMs available for a wireless device 102 from one or more MNOs 114. An MNO 114 can also provide their own set of servers, including various MNO infrastructure servers 312 for managing cellular access, authentication, authorization, subscription, billing, and other associated management functions for cellular wireless services for the wireless device 102, and MNO provisioning servers 116 from which SIM firmware, e.g., eSIMs 208, OTA updates for eSIMs 208, etc., can be accessed, with appropriate authentication, by the wireless device 102.

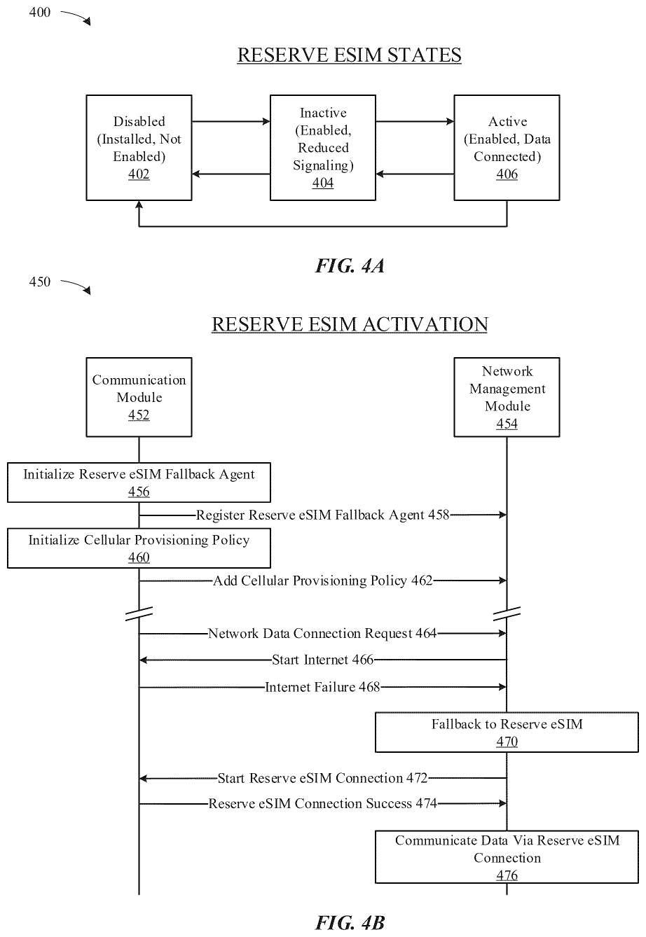

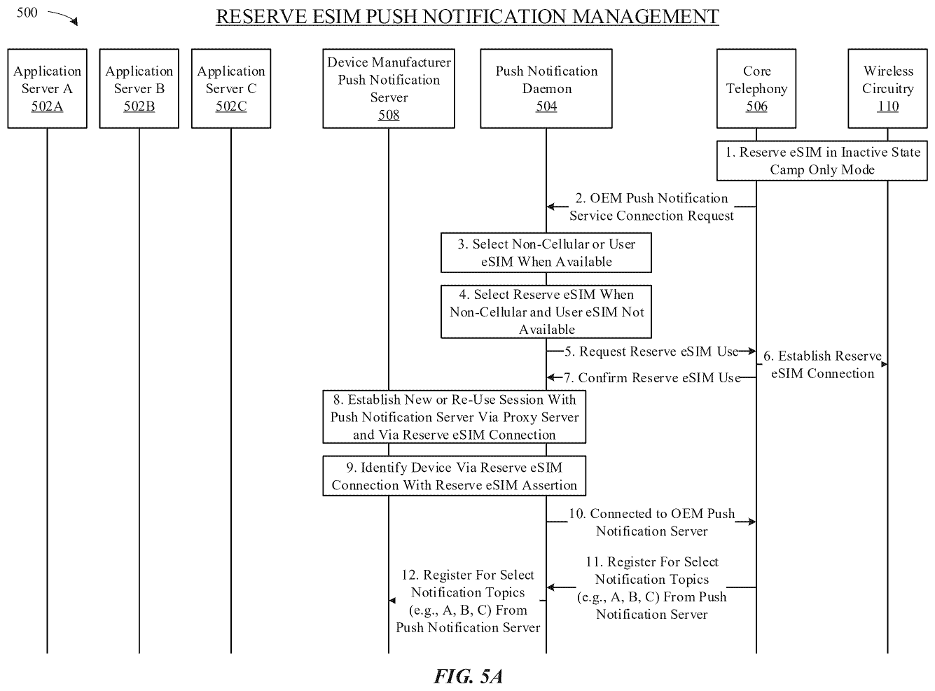

FIG. 4A illustrates a diagram 400 of exemplary states for a reserve eSIM 208 for a wireless device 102. The reserve eSIM 208 can be installed in the wireless device 102 at a manufacturing facility or downloaded to the wireless device 102 after manufacture. The reserve eSIM 208 can be installed on an eUICC 108 of the wireless device 102 can be configured in a disabled state 402. The reserve eSIM 208 cannot be used until being enabled. The reserve eSIM 208 can be reconfigured from the disabled state 402 to an inactive state 404 in which cellular wireless capabilities using the reserve eSIM 208 can be restricted from establishing an active cellular wireless connection with a cellular wireless network, e.g., to reduce signaling and to conserve battery power of the wireless device 102. The inactive state can include i) a cellular airplane mode in which a baseband cellular wireless transceiver is disabled (no cellular wireless transmissions or reception allowed) or ii) a limited network search mode in which a baseband cellular wireless receiver listens for signals from cellular wireless networks to ready the wireless device 102 for future cellular wireless connections but does not transmit or connect to the cellular wireless network using the reserve eSIM while in the inactive state. In some cases, the wireless device 102 can use the reserve eSIM 208 to camp on a cellular wireless network but not form an active data connection with the cellular wireless network until needed. The reserve eSIM 208 can be reconfigured from the inactive state 404 to an active state 406 in which a data connection can be established with a cellular wireless network via the reserve eSIM 208. The wireless device 102 can cause the reserve eSIM 208 to enter and to exit the inactive state 404 based on requirements by system resources and/or requests from applications that are authorized to use the reserve eSIM 208. In some cases use of a cellular wireless connection via the reserve eSIM 208 can be restricted to a particular set of allowed actions, e.g., to allow for an Internet connection to a device manufacturer managed server for device activation, to enable a secure connection to an MNO 114 provisioning server 116 to download a user eSIM 208, to communicate status of various eSIM provisioning operations to a device manufacturer server or to an MNO server, to obtain eSIM status from a device manufacturer MNO services server 310, to receive a limited set of push notification messages from a device manufacturer device services server, such as a push notification server.

Client applications or system resources of the wireless device 102 that are authorized to use the reserve eSIM 208 can receive an indication of availability of the reserve eSIM 208. A client application or system resource can determine whether to request a network connection via the reserve eSIM 208 when available and can assert a requirement for use of the reserve eSIM 208, e.g., to a dynamic reserve eSIM management module. The client application or system resource can indicate completion of use the reserve eSIM 208 assertion when no longer required. When no applications or system resources authorized to use the reserve eSIM 208 require use of the reserve eSIM, the dynamic reserve eSIM management module can reconfigure the reserve eSIM 208 from the active state to the inactive state. The reserve eSIM 208 can remain available for authorized client applications and/or authorized system resources when certain conditions are satisfied. In some cases, a connection via the reserve eSIM 208 can be used to register for one or more push notification topics for which push notifications are allowed to be sent to the wireless device 102 via the reserve eSIM 208 connection. In some cases, the wireless device 102 can implement a procedure to limit time availability of a reserve eSIM 208 connection for push notifications. In some cases, the wireless device 102 can implement an inactivity timer to determine when to discontinue use of a reserve eSIM 208 connection, such as for push notifications.

FIG. 4B illustrates a diagram 450 of an exemplary use of a reserve eSIM 208 installed on an eUICC 108 of a wireless device 102. A communication module 452, which can execute on a processor 104 of the wireless device 102, such as an applications processor or a baseband processor, at 456, can initialize a reserve eSIM fallback agent associated with a reserve eSIM 208. At 458, the communication module 452 can register the reserve fallback agent with a network management module 454, which can also execute on the same processor 104 or another processor 104 of the wireless device 102. At 460, the communication module 452 can initialize a cellular provisioning policy to indicate proper use of the reserve eSIM 208 via the reserve fallback agent. At 462, the communication module 452 can communicate the cellular provisioning policy to the network management module. Subsequently, at 464, the communication module 452 can determine a requirement for a network data connection, e.g., based on a user input action or on a system resource requirement, and can communicate a network data connection request to the network management module 454. In some embodiments, the network management module 454, can be unaware of the inactive state 404 for the reserve eSIM 208. At 466, the network management module 454 can send a request to the communication module 452 to initiate an Internet data connection, e.g., by establishing a non-cellular wireless connection or a cellular wireless connection based on a user eSIM 208. At 452, the communication module 452 can respond to the network management module 454 indicating failure to establish the requested Internet data connection, which can occur when no non-cellular wireless connection can be established and no user eSIMs 208 are installed and enabled on the eUICC 108 of the wireless device 102. At 470, the network management module 454 can fallback to use of the reserve eSIM 208, e.g., in accordance with the cellular provisioning policy received previously from the communication module 452 at 462. At 472, the network management module 454 can send a message to the communication module 452 to establish a network connection using the reserve eSIM 208. At 474, the communication module 452 can respond with an indication of successful establishing of a network connection using the reserve eSIM 208. At 476, the network management module 454 can communicate data via the connection established using the reserve eSIM 208. In some embodiments, as illustrated in FIG. 4B, a provisioning eSIM 208 capability is available for a data connection when no other data connection is available and used as a fallback connection on-demand.

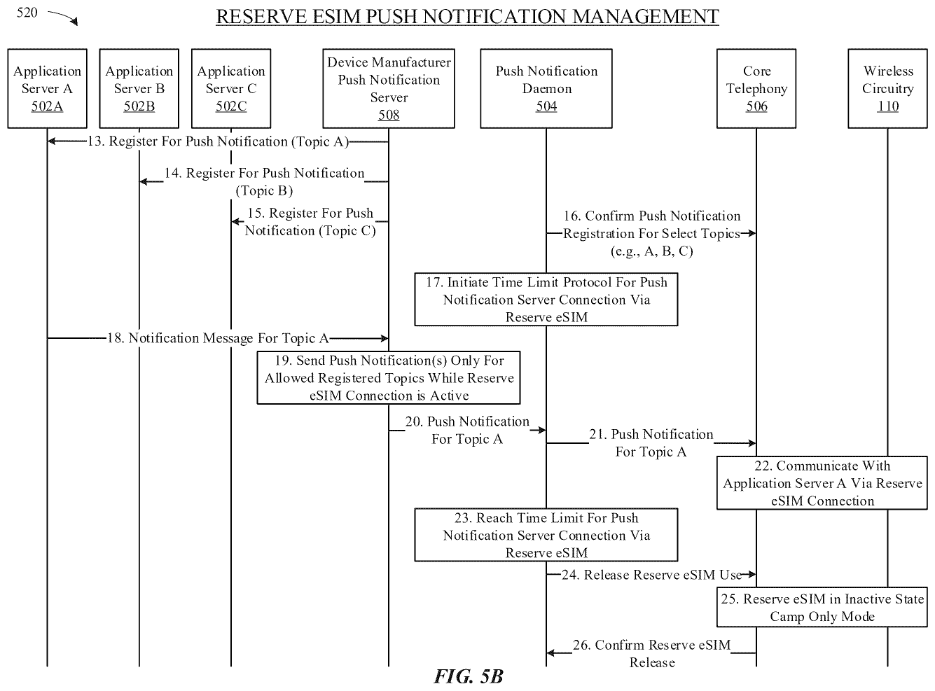

FIGS. 5A and 5B illustrate diagrams 500, 520 of an example of managing push notifications via a reserve eSIM connection for a wireless device 102. At a first step, a core telephony module 506 and wireless circuitry 110 of the wireless device 102 can put a reserve eSIM 208 into an inactive state 404, where the wireless device 102 is camped on a cellular wireless network via the reserve eSIM 208 but unable to establish a data connection with the cellular wireless network. The core telephony module 506 can be implemented in an applications processor and/or in a baseband processor of the wireless device 102. The wireless circuitry 110 can include hardware and software/firmware, including a baseband processor, to enable wireless connections for the wireless device 102. At a second step, the core telephony module 506 sends a request message to a push notification daemon 504 of the wireless device 102 to establish a connection for a push notification service to a push notification server 508 of an original equipment manufacturer (OEM), also referred to herein as a device manufacturer. The push notification daemon 504 can provide a service for managing push notifications from a device manufacturer push notification server 508. The push notification daemon 504 can be one of multiple device services daemons resident on an application processor of the wireless device 102. At a third step, the push notification daemon 504 can determine to select a non-cellular wireless connection or a user eSIM cellular wireless connection, when available, to use for communicating with the device manufacturer push notification server 508. At a fourth step, the push notification daemon 504 can determine to select a reserve eSIM cellular wireless connection, when no alternative wireless (e.g., non-cellular or user eSIM) or wired connection is available, to use for communicating with the device manufacturer push notification server 508. At a fifth step, the push notification daemon 504 can send to the core telephony module 506 a request to use the reserve eSIM 208. At a sixth step, the core telephony module 506 can cause the wireless circuitry 110 to transition the reserve eSIM 208 to an active state (if required) and establish an active data connection via the reserve eSIM 208. At a seventh step, the core telephony module 506 can respond to the push notification daemon 504 confirming availability of a reserve eSIM connection for use by the push notification daemon 504. At an eighth step, the push notification daemon 504 establishes a new session or resumes a previous session, via the reserve eSIM connection, with the device manufacturer push notification server 508, which can be one of one or more device manufacturer device services servers 308. In some cases, the push notification daemon 504 communicates directly with the device manufacturer push notification server 508. In some cases, the push notification daemon 504 communicates indirectly with the device manufacturer push notification server 508 via a proxy server, which can be another of the one or more device manufacturer device services servers 308. In some embodiments, the proxy server can be configured to handle communication via reserve eSIM connections. In some embodiments, the push notification daemon 504 indicates to the device manufacturer push notification server 508 that the session is using (and/or will use) a reserve eSIM connection. At a ninth step, the push notification daemon 504 can identify the wireless device 102 to the device manufacturer push notification server 508 and indicate use of the reserve eSIM connection. In some embodiments, the push notification daemon 504 indicates to the device manufacturer push notification server 508 use of a reserve eSIM connection for communication for push notifications (and associated communications) in a header of a device capability message. In some embodiments, the device manufacturer push notification server 508 determines that the wireless device 102 is using a reserve eSIM connection based on receiving communication to establish or re-use a session via a proxy server, where the proxy server is known to be used for reserve eSIM connections. At a tenth step, the push notification daemon 504 can indicate to the core telephony module 506 that connection to the device manufacturer push notification server 508 is available via the reserve eSIM connection.

As the reserve eSIM connection can be restricted for use to only a subset of push notification messages that can be sent to the wireless device 102, the wireless device 102 can be configured to request that push notification messages for particular push notification topics be allowed to be communicated via the reserve eSIM connection. Exemplary push notification topics include user eSIM provisioning, eSIM transfer, and device activation. At an eleventh step, the core telephony module 506 sends a message to the push notification daemon 504 to register for one or more push notification topics, e.g., A, B, and/or C, to receive push notification messages for the requested push notification topics via the reserve eSIM connection. At a twelfth step, the push notification daemon 504 sends a message to the device manufacturer push notification server 508 to register for the requested one or more push notification topics, e.g., A, B, and/or C. In some embodiments, the core telephony module 506 can restrict requests for push notifications to only those allowed via a reserve eSIM connection. In some embodiments, the push notification daemon 504 can filter and forward requests from the core telephony module 506 (or other modules) for push notifications to a set of allowed push notification topics. In some embodiments, the device manufacturer push notification server 508 can filter registration requests for push notification messages to only those allowed via the reserve eSIM connection, when the reserve eSIM connection is used for communication by the device manufacturer push notification server 508 to the wireless device 102.

For the example of FIGS. 5A and 5B, we assume that push notification topics A, B, and C are included in the allowed set of push notification topics for which push notification messages can be communicated to the wireless device 102 via the reserve eSIM connection. At a thirteenth step, the device manufacturer push notification server 508 can send a message to an application server A, 502A, to register the wireless device 102 to receive push notifications for push notification topic A. At a fourteenth step, the device manufacturer push notification server 508 can send a message to an application server B, 502B, to register the wireless device 102 to receive push notifications for push notification topic B. At a fifteenth step, the device manufacturer push notification server 508 can send a message to an application server C, 502C, to register the wireless device 102 to receive push notifications for push notification topic C. In some embodiments, the respective application servers, 502A, 502B, 502C, can be unaware that the push notifications will be provided to the wireless device 102 via a reserve eSIM connection. In some embodiments, the device manufacturer push notification server 508 acts as a gatekeeper to filter push notifications for the wireless device 102 to only those allowed to be communicated via the reserve eSIM connection. At a sixteenth step, the push notification daemon 504 confirms to the core telephony module 506 registration of the wireless device 102 with one or more application servers 502A, 502B, 502C for push notification topics A, B, and C. While FIGS. 5A and 5B indicate individual application servers handling different push notification topics, in some embodiments, an application server can provide push notifications for more than one push notification topic.

In some embodiments, to limit availability of the reserve eSIM connection for push notification messages, e.g., to particular time periods, such as X minutes per Y hours per Z days, the push notification daemon 504, at a seventeenth step, initiates a time limit protocol for use of the reserve eSIM connection to the device manufacturer push notification server. At an eighteenth step, the device manufacturer push notification server 508 receives a notification message for push notification topic A from application server A, 502A. At a nineteenth step, the device manufacturer push notification server 508 allows push notifications to be sent to the wireless device 102 only for allowed and registered push notification topics while the reserve eSIM connection is active and used by the wireless device 102 for receiving push notifications. As the wireless device 102 is registered for push notification topic A, which is allowed via the reserve eSIM connection, at a twentieth step, the device manufacturer push notification server 508 can send a push notification for push notification topic A to the push notification daemon 504 on the wireless device 102. At a twenty-first step, the push notification daemon 504 can forward the push notification for push notification topic A to the core telephony module 506 (e.g., when the push notification topic regards availability of an eSIM for provisioning to the wireless device 102). At a twenty-second step, the core telephony module 506 and wireless circuitry 110, e.g., a baseband processor and/or an eUICC 108 of the wireless device 102, can communicate with the application server A, 502A, via the reserve eSIM connection. For example, the application server A, 502A, can be a provisioning server 116 for an MNO 114, and the push notification topic A can pertain to provisioning of an eSIM 208 to the eUICC 108 of the wireless device 102. As another example, the application server A, 502A, can be a device manufacturer lookup server from which the wireless device 102 can determine availability of one or more eSIMs 208 reserved for the wireless device 102, e.g., where the push notification topic A can pertain to provisioning of an eSIM 208 or transfer of cellular wireless service associated with an eSIM 208 to the wireless device 102. As a further example, the application server A, 502A, can be a device manufacturer activation server and the push notification topic A can pertain to activation of the wireless device 102. At a twenty-third step, a time limit is reached for the connection to the device manufacturer push notification server 508 via the reserve eSIM connection. At a twenty-fourth step, the push notification daemon 504 sends a message to the core telephony module 506 to release use of the reserve eSIM connection. At a twenty-fifth step, when no other service or module of the wireless device 102 requires or is able to use the reserve eSIM connection, the core telephony module 506 and the wireless circuitry 110 tear down the reserve eSIM connection to the cellular wireless network and reconfigure the reserve eSIM 208 from the active state to the inactive state, where the wireless device 102 continues to camp on the cellular wireless network via the reserve eSIM 208. At a twenty-sixth step, the core telephony module 506 confirms to the push notification daemon 504 that release of the reserve eSIM connection has completed.

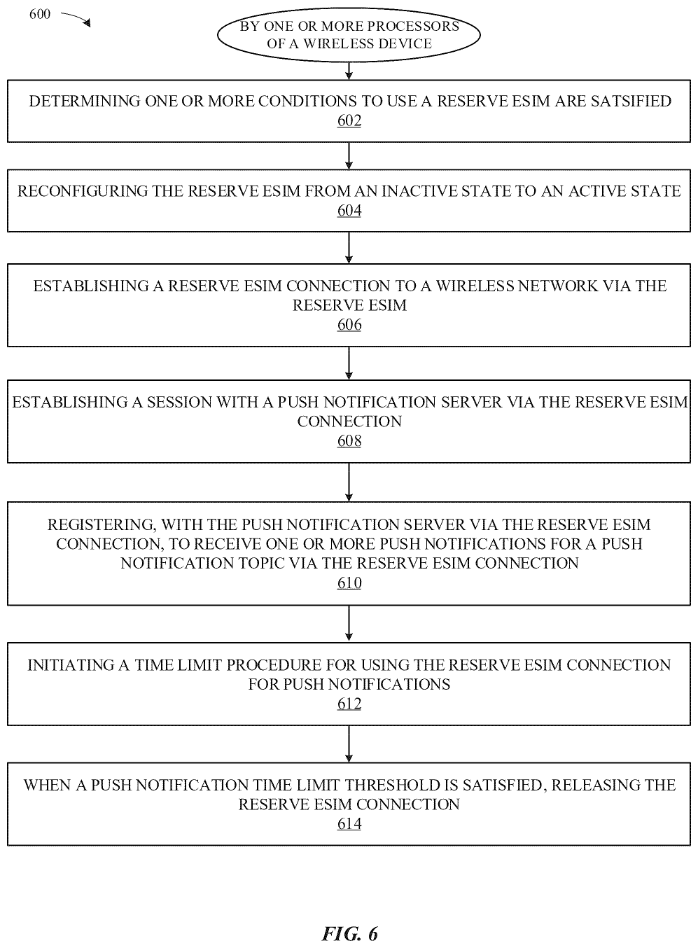

FIG. 6 illustrates a flowchart 600 of an exemplary method performed by one or more processors 104 of a wireless device 102 to manage push notifications for the wireless device 102 via a reserve eSIM connection. At 602, the one or more processors 104 determine one or more conditions to use a reserve eSIM 208 are satisfied. At 604, the one or more processors 104 reconfigure the reserve eSIM 208 from an inactive state to an active state. At 606, the one or more processors 104 establish a reserve eSIM connection to a wireless network via the reserve eSIM 208. At 608, the one or more processors 104 establish a session with a push notification server 508 via the reserve eSIM connection. At 610, the one or more processors 104 register the wireless device 102 to receive one or more push notifications for a push notification topic from the push notification server 508 via the reserve eSIM connection. At 612, the one or more processors 104 initiate a time limit procedure for using the reserve eSIM connection for push notifications. At 614, the one or more processors 104 release the reserve eSIM connection to the wireless device 102 when a push notification time limit threshold is satisfied.

In some embodiments, the method further includes the one or more processors 104 of the wireless device 102 reconfiguring the reserve eSIM 208 from the active state to the inactive state, when the push notification time limit threshold is satisfied. In some embodiments, the inactive state includes a camp only mode for the wireless device 102 to camp on the wireless network with reduced signaling. In some embodiments, communication via the reserve eSIM connection between the wireless device 102 and the push notification server 508 includes communication via a proxy server. In some embodiments, the method further includes the one or more processors 104 of the wireless device 102 identifying, to the push notification server 508 in association with establishment of the session, use of the reserve eSIM connection for push notifications. In some embodiments, the method further includes the wireless device 102 receiving via the reserve eSIM connection from the push notification server 508 a push notification for the push notification topic. In some embodiments, the method further includes the wireless device 102 responsive to receipt of the push notification, communicating with an application server 502 associated with the push notification topic via the reserve eSIM connection. In some embodiments, the push notification topic includes provisioning of a user eSIM 208 to the wireless device 102. In some embodiments, the push notification topic includes transfer of cellular wireless service associated with a SIM or a user eSIM 208 of a second wireless device 102 to the wireless device 102. In some embodiments, the application server 502 associated with the push notification topic includes an MNO provisioning server 116. In some embodiments, the application server 502 associated with the push notification topic includes a device manufacturer MNO services server 310 configured to provide notification of pending user eSIMs 208 for the wireless device 102. In some embodiments, the push notification topic includes wireless device activation. In some embodiments, the application server 502 associated with the push notification topic includes a device manufacturer devices services server 308 configured for wireless device activation.

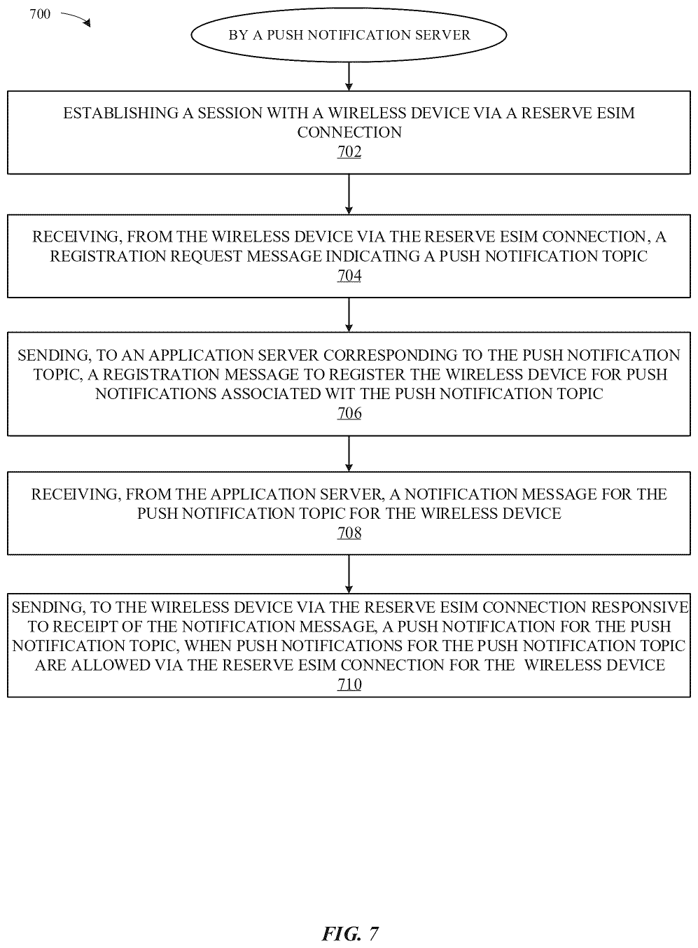

FIG. 7 illustrates a flowchart 700 of an exemplary method performed by a push notification server 508 to manage push notifications for a wireless device 102 via a reserve eSIM connection. At 702, the push notification server 508 establishes a session with the wireless device 102 via the reserve eSIM connection. At 704, the push notification server 508 receives, from the wireless device 102 via the reserve eSIM connection, a registration request message indicating a push notification topic. At 706, the push notification server 508 sends, to an application server 502 corresponding to the push notification topic, a registration message to register the wireless device 102 for push notifications associated with the push notification topic. At 708, the push notification server 508 receives, from the application server 502, a notification message for the push notification topic for the wireless device 102. At 710, the push notification server 508 sends, to the wireless device 102 via the reserve eSIM connection responsive to receipt of the notification message, a push notification for the push notification topic, when push notifications for the push notification topic are allowed via the reserve eSIM connection for the wireless device 102.

In some embodiments, he push notification server 508 is further configured to receive, from a second application server 502 while the reserve eSIM connection to the wireless device 102 is active, a second notification message for a second push notification topic for the wireless device 102, and to refrain from sending to the wireless device 102 a second push notification when push notifications for the second push notification topic are disallowed via the reserve eSIM connection. In some embodiments, the push notification topic includes provisioning or transfer of a user eSIM 208 to the wireless device 102, and the application server 502 associated with the push notification topic comprises an MNO provisioning server 116 or a device manufacturer MNO services server 310 configured to provide notification of pending user eSIMs 208 for the wireless device 102. In some embodiments, the push notification topic includes wireless device activation, and the application server 502 associated with the push notification topic includes a device manufacturer devices services server 308 configured for wireless device activation.

### Representative Device

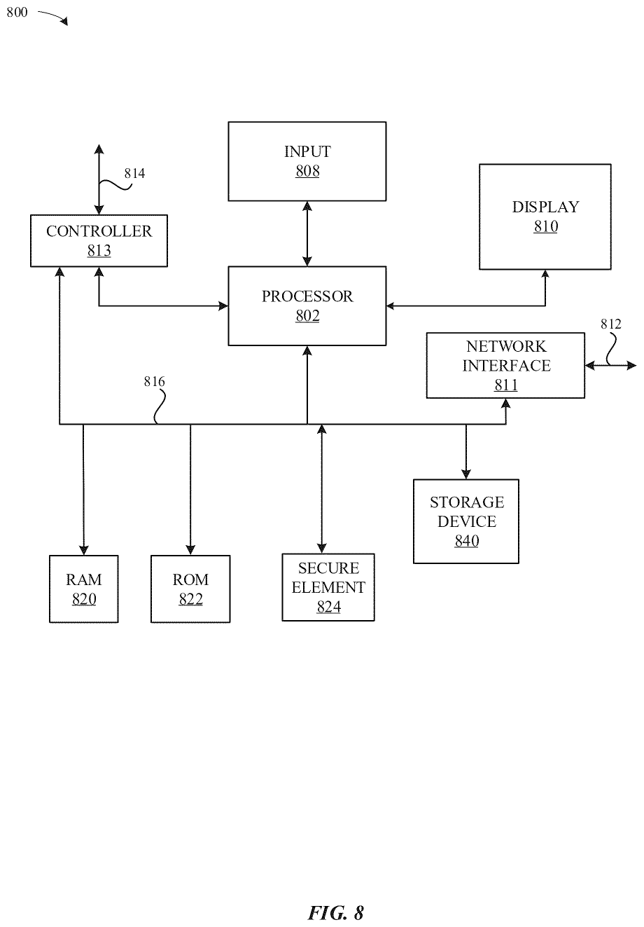

FIG. 8 illustrates a detailed view of a representative computing device 800 that can be used to implement various methods described herein, according to some embodiments. In particular, the detailed view illustrates various components that can be included in the wireless device 102. As shown in FIG. 8, the computing device 800 can include a processor 802 that represents a microprocessor or controller for controlling the overall operation of computing device 800. The computing device 800 can also include a user input device 808 that allows a user of the computing device 800 to interact with the computing device 800. For example, the user input device 808 can take a variety of forms, such as a button, keypad, dial, touch screen, audio input interface, visual/image capture input interface, input in the form of sensor data, etc. Still further, the computing device 800 can include a display 810 that can be controlled by the processor 802 to display information to the user. A data bus 816 can facilitate data transfer between at least a storage device 840, the processor 802, and a controller 813. The controller 813 can be used to interface with and control different equipment through an equipment control bus 814. The computing device 800 can also include a network/bus interface 811 that communicatively couples to a data link 812. In the case of a wireless connection, the network/bus interface 811 can include a wireless transceiver.

The computing device 800 also includes a storage device 840, which can comprise a single disk or a plurality of disks (e.g., hard drives), and includes a storage management module that manages one or more partitions within the storage device 840. In some embodiments, storage device 840 can include flash memory, semiconductor (solid state) memory or the like. The computing device 800 can also include a Random Access Memory (RAM) 820 and a Read-Only Memory (ROM) 822. The ROM 822 can store programs, utilities or processes to be executed in a non-volatile manner. The RAM 820 can provide volatile data storage, and stores instructions related to the operation of the computing device 800. The computing device 800 can further include a secure element (SE) 824, which can represent secure storage for cellular wireless system access by the wireless device 102, such as an eUICC 108 on which to store one or more eSIMs 208 and/or a UICC 118 on which to store a pSIM profile.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High-Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for management of push notifications for a reserve electronic subscriber identity module (eSIM) connection for a wireless device, the method comprising:
by one or more processors of the wireless device:
determining one or more conditions to use a reserve eSIM are satisfied;
reconfiguring the reserve eSIM from an inactive state to an active state;
establishing a reserve eSIM connection to a wireless network via the reserve eSIM;
establishing a session with a push notification server via the reserve eSIM connection;
registering, with the push notification server via the reserve eSIM connection, to receive one or more push notifications for a push notification topic via the reserve eSIM connection;
initiating a time limit procedure for using the reserve eSIM connection for push notifications; and
when a push notification time limit threshold is satisfied, releasing the reserve eSIM connection.

2. The method of claim 1, further comprising:
when the push notification time limit threshold is satisfied, reconfiguring the reserve eSIM from the active state to the inactive state.

3. The method of claim 1, wherein the inactive state comprises a camp only mode for the wireless device to camp on the wireless network with reduced signaling.

4. The method of claim 1, wherein communication via the reserve eSIM connection between the wireless device and the push notification server includes communication via a proxy server.

5. The method of claim 1, further comprising:
identifying, by the wireless device to the push notification server in association with establishment of the session, use of the reserve eSIM connection for push notifications.

6. The method of claim 1, wherein:
receiving, by the wireless device via the reserve eSIM connection from the push notification server, a push notification for the push notification topic.

7. The method of claim 6, further comprising:
responsive to receipt of the push notification, communicating with an application server associated with the push notification topic via the reserve eSIM connection.

8. The method of claim 7, wherein the push notification topic comprises provisioning of a user eSIM to the wireless device.

9. The method of claim 8, wherein the application server associated with the push notification topic comprises a mobile network operator (MNO) provisioning server.

10. The method of claim 8, wherein the application server associated with the push notification topic comprises a device manufacturer MNO services server configured to provide notification of pending user eSIMs for the wireless device.

11. The method of claim 7, wherein the push notification topic comprises wireless device activation.

12. The method of claim 11, wherein the application server associated with the push notification topic comprises a device manufacturer devices services server configured for wireless device activation.

13. The method of claim 7, wherein the push notification topic comprises transfer of cellular wireless service associated with a SIM or a user eSIM of a second wireless device to the wireless device.

14. The method of claim 13, wherein the application server associated with the push notification topic comprises a mobile network operator (MNO) provisioning server.

15. The method of claim 13, wherein the application server associated with the push notification topic comprises a device manufacturer MNO services server configured to provide notification of pending user eSIMs for the wireless device.

16. A method for management of push notifications for a reserve electronic subscriber identity module (eSIM) connection for a wireless device, the method comprising:
by a push notification server:
establishing a session with a wireless device via the reserve eSIM connection;
receiving, from the wireless device via the reserve eSIM connection, a registration request message indicating a push notification topic;
sending, to an application server corresponding to the push notification topic, a registration message to register the wireless device for push notifications associated with the push notification topic;
receiving, from the application server, a notification message for the push notification topic for the wireless device; and
sending, to the wireless device via the reserve eSIM connection responsive to receipt of the notification message, a push notification for the push notification topic, when push notifications for the push notification topic via the reserve eSIM connection are allowed for the wireless device.

17. The method of claim 16, wherein the push notification server is further configured to:
receive, from a second application server while the reserve eSIM connection to the wireless device is active, a second notification message for a second push notification topic for the wireless device; and
refrain from sending to the wireless device a second push notification when push notifications for the second push notification topic are disallowed via the reserve eSIM connection.

18. The method of claim 16, wherein:
the push notification topic comprises provisioning or transfer of a user eSIM to the wireless device; and
the application server associated with the push notification topic comprises a mobile network operator (MNO) provisioning server or a device manufacturer MNO services server configured to provide notification of pending user eSIMs for the wireless device.

19. The method of claim 16, wherein:
the push notification topic comprises wireless device activation; and
the application server associated with the push notification topic comprises a device manufacturer devices services server configured for wireless device activation.

20. One or more processors for management of a reserve electronic subscriber identity module (eSIM) connection for a wireless device, wherein the one or more processors are configured to:
determine one or more conditions to use a reserve eSIM are satisfied;
reconfigure the reserve eSIM from an inactive state to an active state;
establish a reserve eSIM connection to a wireless network via the reserve eSIM;
establish a session with a push notification server via the reserve eSIM connection;
register, with the push notification server via the reserve eSIM connection, to receive one or more push notifications for a push notification topic via the reserve eSIM connection;
initiate a time limit procedure for using the reserve eSIM connection for push notifications; and
when a push notification time limit threshold is satisfied, release the reserve eSIM connection.
